(19) United States
(12) Patent Application Publication
(10) Pub. No.: US 2008/0297463 A1
(43) Pub. Date: Dec. 4, 2008

(54) LIQUID CRYSTAL DISPLAY APPARATUS AND LUMINANCE CONTROL METHOD THEREOF

(76) Inventors: Yasutaka TSURU, Kawasaki (JP); Satoshi Ouchi, Kamakura (JP); Seiji Murata, Yokohama (JP); Mayumi Nagayoshi, Chofu (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/017,371

(22) Filed: Jan. 22, 2008

(30) Foreign Application Priority Data
Jan. 22, 2007 (JP) 2007-011526

(51) Int. Cl. G09G 3/36; G02F 1/13357

(52) U.S. Cl. 345/102

(57) ABSTRACT

For the purpose of suppressing untrue black with the change in luminance of video, which is displayed as the same object, being reduced to improve the contrast, there is provided a liquid crystal display apparatus that is capable of: extracting the pixel frequency distribution of an input video signal on a luminance level basis, and extracting the pixel frequency distribution of specific color from a color-difference signal of input video in a screen area, the color-difference signal being determined from the luminance distribution of a plurality of backlights; on the basis of the result of the extraction, determining the control amount of the luminance of the plurality of backlights, and the correction amount of the luminance of a liquid crystal panel, on a screen area basis; controlling the luminance of the plurality of backlights on the basis of the control amount of the luminance; and at the same time, controlling the luminance of the input video signal on the basis of the correction amount of the luminance.

### CLAIM OF PRIORITY

The present application claims priority from Japanese application serial No. P2007-011526, filed on Jan. 22, 2007, the content of which is hereby incorporated by reference into this application.

### BACKGROUND OF THE INVENTION

1. Technical Field of the Invention

The present invention relates to liquid crystal display apparatuses, and more particularly to luminance control techniques thereof.

2. Description of the Related Art

In recent years, transmissive liquid crystal display apparatuses are achieving widespread use as large-screen flat televisions and large-screen flat displays. The transmissive liquid crystal display apparatus is configured to use, in combination, a liquid crystal panel functioning as an optical isolation shutter, and light source units located on the back of the liquid crystal panel. Each of the light source units is called “backlight”. The increase and decrease of the light quantity of each backlight causes the maximum luminance of the transmissive liquid crystal display apparatus to increase and decrease. The increase of the luminance of each backlight is indispensable for displaying bright images. However, because the liquid crystal panel cannot completely isolate a light beam coming from each backlight under present circumstances, if the light quantity of each backlight is increased, black becomes faded in dark part of input video; in other words, what is called, a phenomenon of “untrue black” (hereinafter referred to as “untrue black”) occurs, which often leads to the decrease in contrast. JP-A-2002-14660 is disclosed as a technique for improving the untrue black, for example. For the purpose of providing a liquid crystal display apparatus that is capable of individually and independently controlling the contrast and luminance of a video signal and the luminance of a plurality of backlights with high accuracy inresponse to a luminance signal of the minute area and the luminance distribution, and that is capable of extending a dynamic range of video and reducing the power consumption, JP-A-2002-14660 discloses the technique in which an area occupation ratio of one field or one frame is determined on a luminance level basis to calculate the control amount of the image quality from the area occupation ratio so that not only the contrast and the luminance, but also the luminance of the backlights, are controlled.

### SUMMARY OF THE INVENTION

For example, a case where an input video signal shown in FIG. 9 is displayed by the liquid crystal display apparatus disclosed in the JP-A-2002-14660 will be considered as below. FIG. 9 is a diagram illustrating an image displayed on a screen in which the upper half of a background (screen area A) is white, the lower half of the background (screen area B) is black, and a person's face colored with light brown (skin color) is located in the central portion of the screen. As a result of extracting the luminance distribution of this image, the screen area A includes many pixel frequencies whose luminance level is high as shown in FIG. 10A. On the other hand, the screen area B includes many pixel frequencies whose luminance level is low as shown in FIG. 10B. Therefore, in the upper part of the screen, the light quantity of the backlight light source 6A in the liquid crystal display apparatus disclosed in JP-A-2002-14660 is kept high, and accordingly the luminance is high. On the other hand, in the lower part of the screen, the light quantity of the backlight light source 6B is decreased, which causes the luminance to decrease. Along with the above operation, the luminance of part of the person's face, which is included in the screen area A, becomes high, whereas the luminance of part of the person's face, which is included in the screen area B, becomes low. However, in actuality, the person's face located in the central portion of the screen should be displayed with uniform luminance. Because the eyes of a human being are in particular sensitive to the difference in the luminance and hue of light brown (skin color), the person's face whose luminance has changed will bring discomfort to the viewer.

Taking the above-described situation of the prior art into consideration, objects of the present invention are to suppress untrue black with the change in luminance of video, which is displayed as the same object (like the person's face described above), reduced in response to characteristics of the displayed video in a liquid crystal display apparatus, and thereby to enable the improvement of contrast.

The present invention is a technique that can achieve the above-described objects.

To be more specific, according to the present invention, there is provided a liquid crystal display apparatus that is configured to be capable of: extracting the pixel frequency distribution of an input video signal on a luminance level basis, and extracting the pixel frequency distribution of specific color from a color-difference signal of input video in a screen area, the color-difference signal being determined from the luminance distribution of a plurality of backlights; on the basis of the result of the extraction, determining the control amount of the luminance of the plurality of backlights, and the correction amount of the luminance of a liquid crystal panel, on a screen area basis; controlling the luminance of the plurality of backlights on the basis of the control amount of the luminance; and at the same time, controlling the luminance of the input video signal on the basis of the correction amount of the luminance.

### BRIEF DESCRIPTION OF THE DRAWINGS

FIG. 1 is a diagram illustrating as an example a configuration of a liquid crystal display apparatus according to an embodiment of the present invention;

FIG. 2 is a diagram illustrating how a screen of the liquid crystal display apparatus shown FIG. 1 is divided into screen areas;

FIGS. 3A through 3H are charts each illustrating characteristics of a luminance distribution filter included in the liquid crystal display apparatus shown in FIG. 1;

FIGS. 4A through 4H are charts each illustrating, on a luminance level basis, the pixel frequency distribution of the image shown in FIG. 2;

FIGS. 5A through 5H are charts each illustrating characteristics of a color distribution filter included in the liquid crystal display apparatus shown in FIG. 1;

FIGS. 6A through 6H are charts each illustrating the pixel frequency distribution of each specific color of the image shown in FIG. 2;

FIG. 7 is a flowchart illustrating how a backlight driving control signal is generated in the liquid crystal display apparatus shown in FIG. 1;

FIGS. 8A, 8B are charts each illustrating a backlight driving control signal at the time of generation thereof;

FIG. 9 is a diagram in which problems of the present invention are described, illustrating a divided screen and an input video signal; and

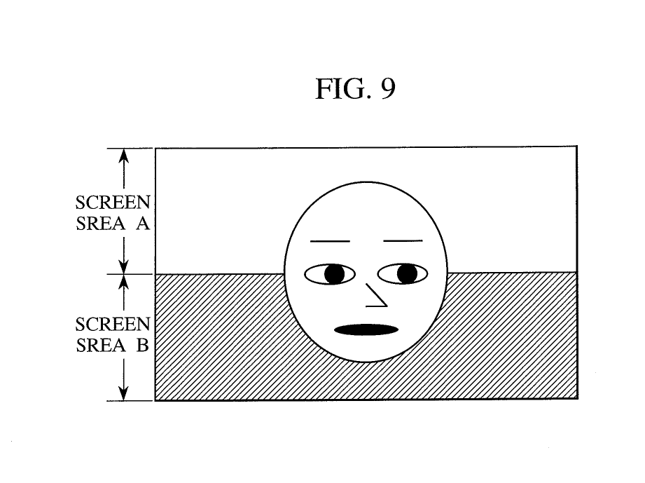

FIGS. 10A, 10B are charts in which problems of the present invention are described, each illustrating the luminance frequency distribution of screen areas.

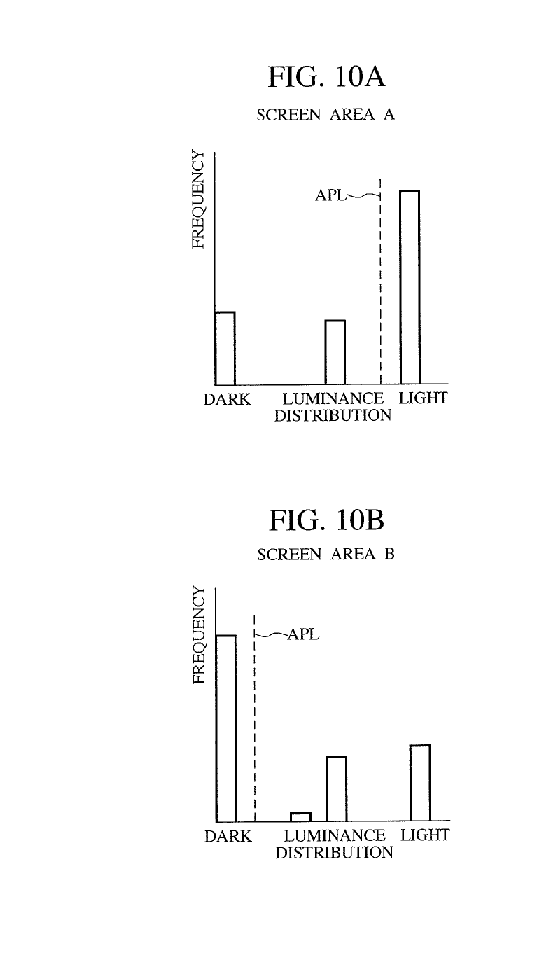

### DETAILED DESCRIPTION OF THE PREFERRED EMBODIMENTS

Embodiments of the present invention will be described with reference to drawings as below.

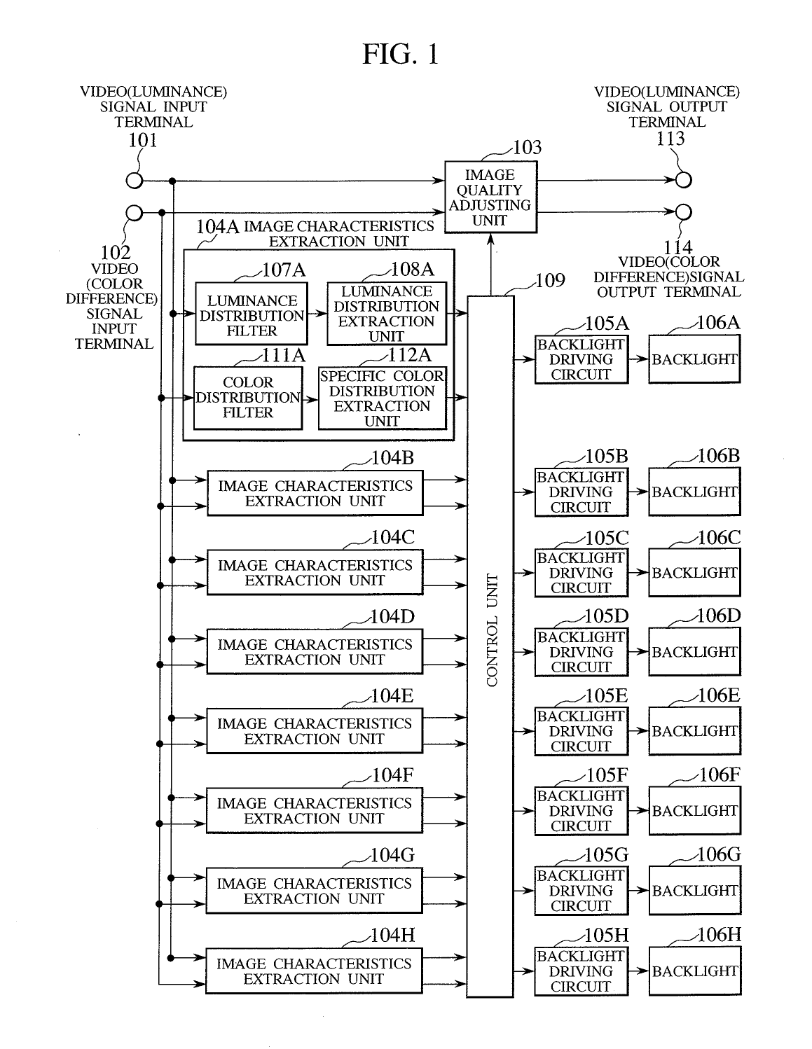

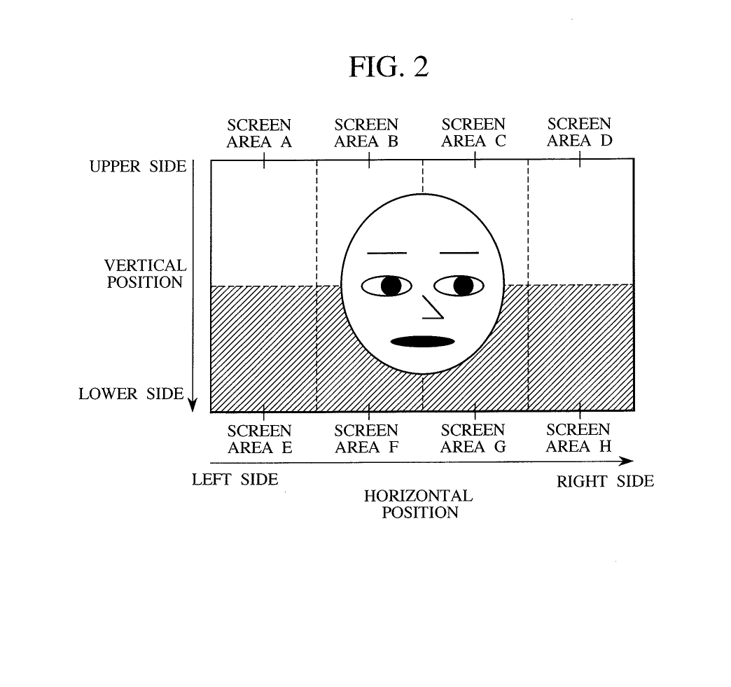

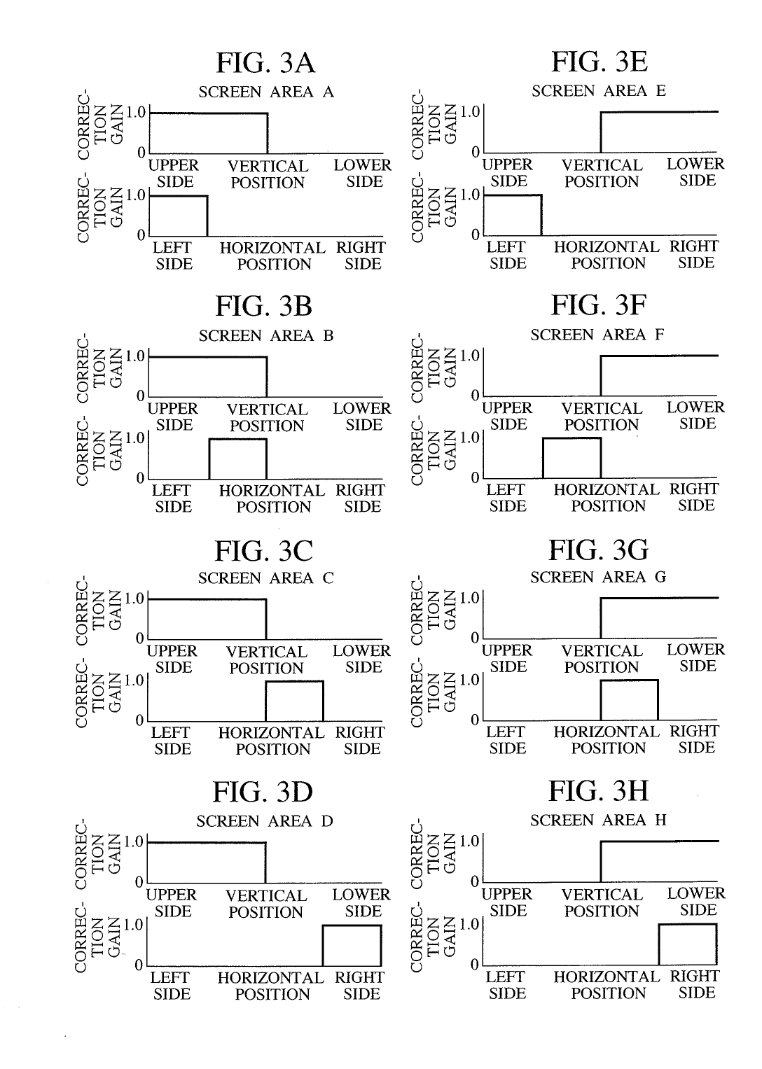

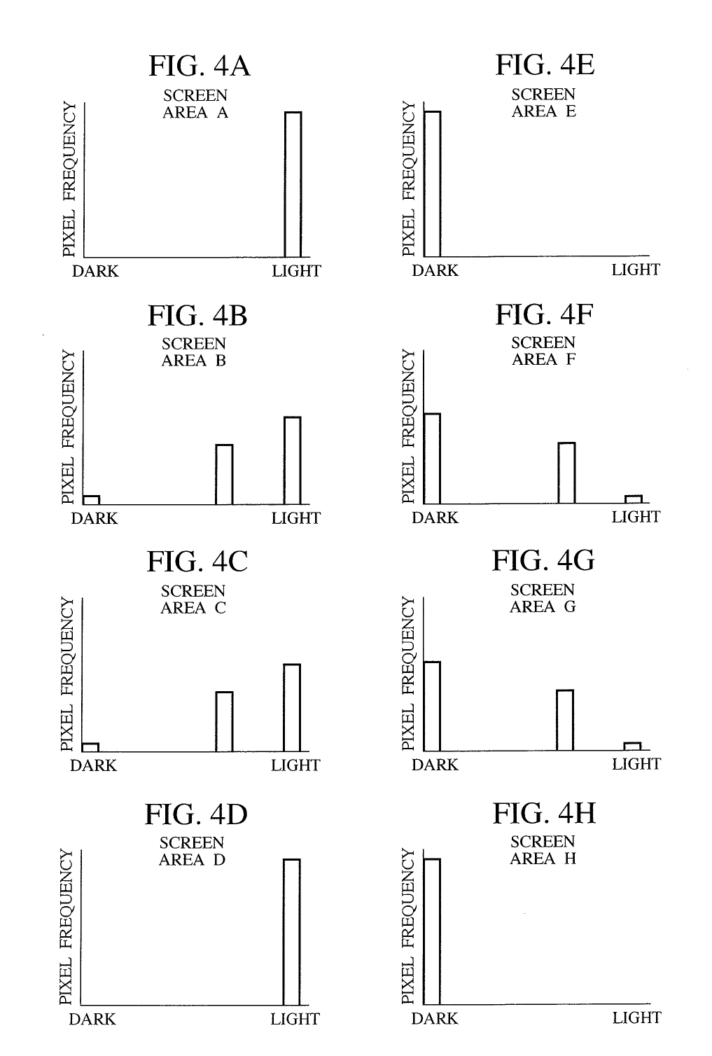

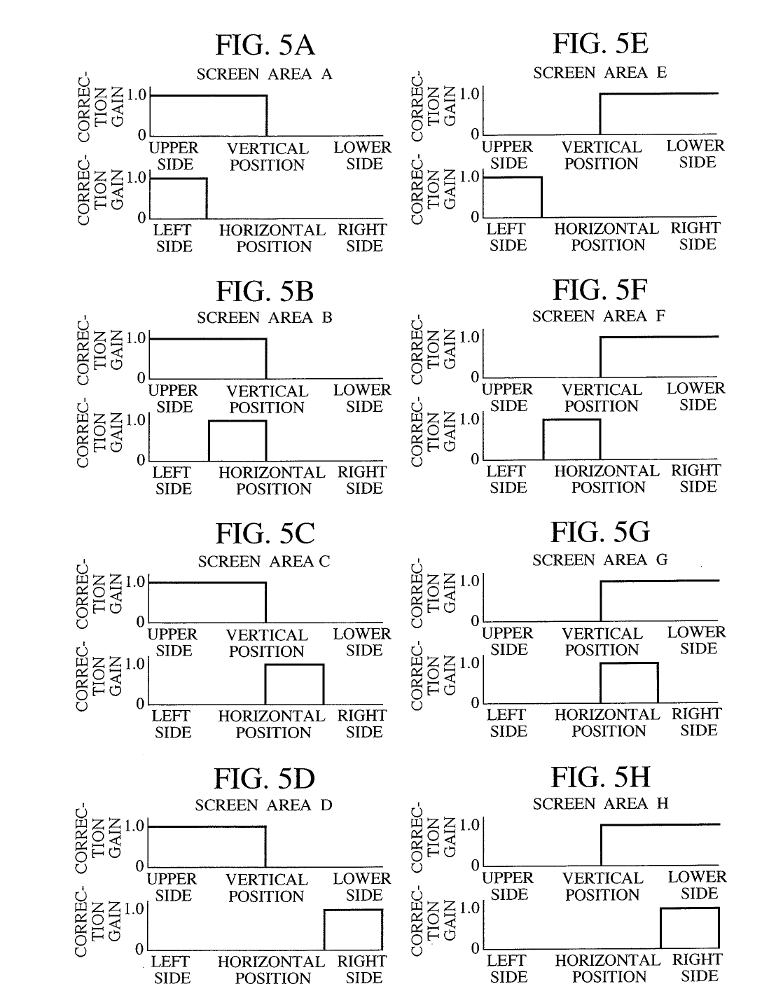

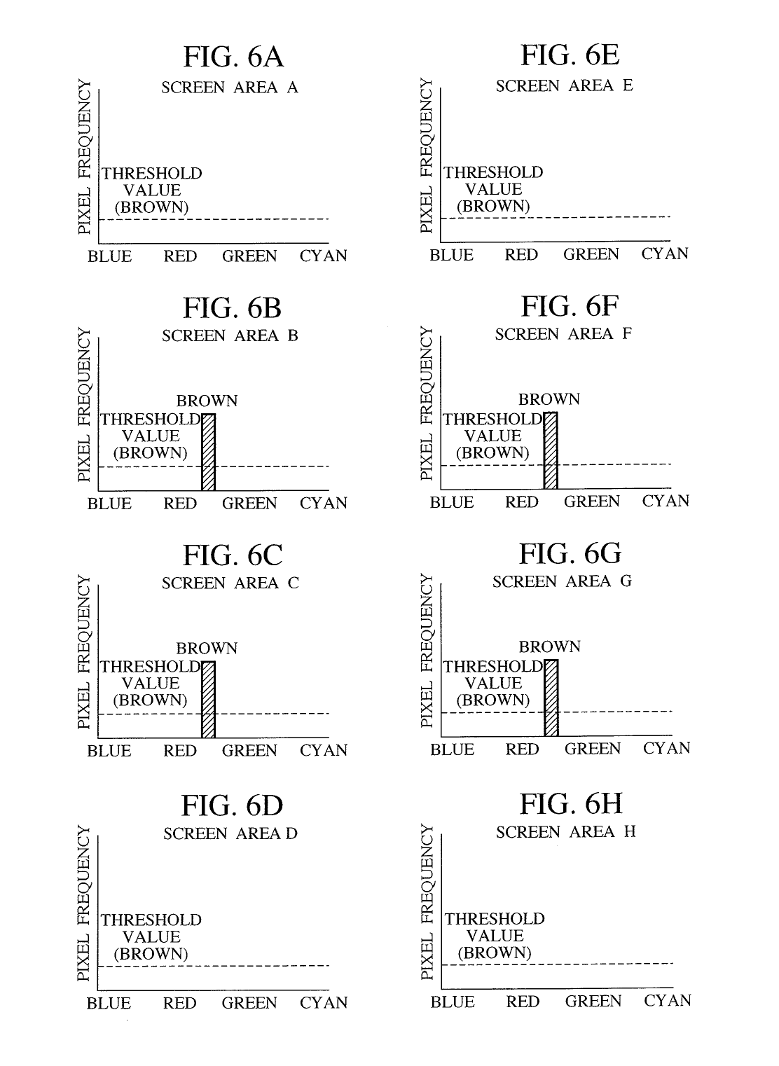

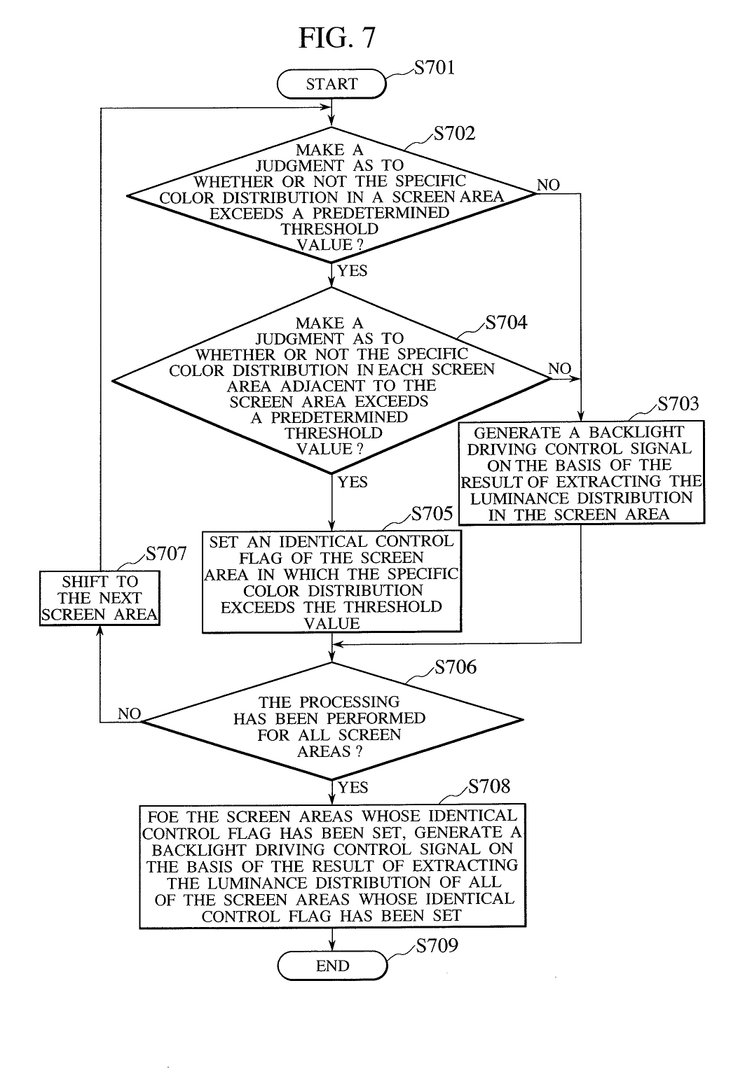

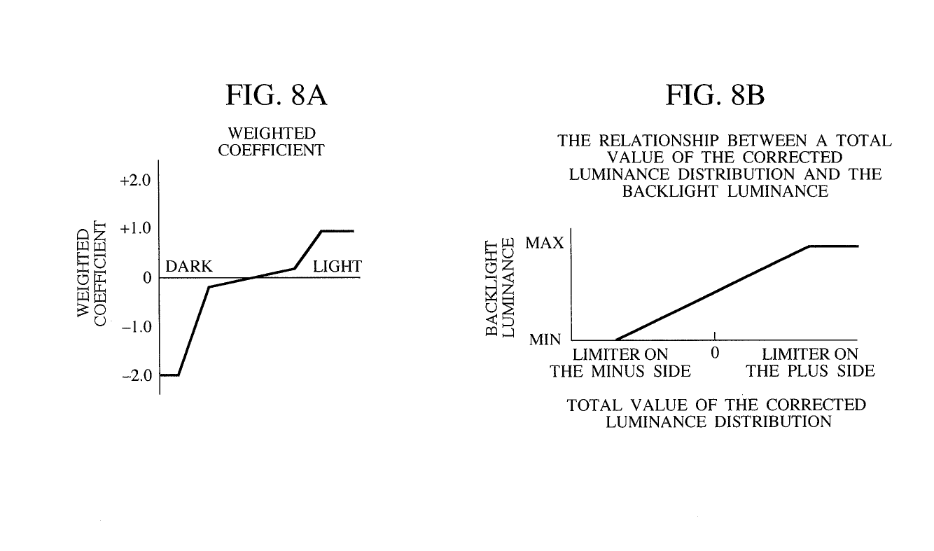

FIGS. 1 through 8 are diagrams each illustrating a liquid crystal display apparatus according to one embodiment of the present invention. FIG. 1 is a diagram illustrating as an example a configuration of the liquid crystal display apparatus according to the embodiment of the present invention. FIG. 2 is a diagram illustrating how a screen of the liquid crystal display apparatus shown FIG. 1 is divided into screen areas. FIGS. 3A through 3H are charts each illustrating characteristics of a luminance distribution filter included in the liquid crystal display apparatus shown in FIG. 1. FIGS. 4A through 4H are charts each illustrating, on a luminance level basis, the pixel frequency distribution of the image shown in FIG. 2. FIGS. 5A through 5H are charts each illustrating characteristics of a color distribution filter included in the liquid crystal display apparatus shown in FIG. 1. FIGS. 6A through 6H are charts each illustrating the pixel frequency distribution of each specific color of the image shown in FIG. 2. FIG. 7 is a flowchart illustrating how a backlight driving control signal is generated in the liquid crystal display apparatus shown in FIG. 1. FIGS. 8A, 8B are charts each illustrating a backlight driving control signal at the time of generation thereof.

As shown in FIG. 2, the liquid crystal display apparatus shown in FIG. 1 is configured to control each of eight screen areas in total, the eight screen areas being formed by dividing the whole screen into two in the longitudinal direction, and by dividing the whole screen into four in the lateral direction.

In FIG. 1, reference numeral 101 denotes a video (luminance) signal input terminal into which a video (luminance) signal is inputted; reference numeral 102 denotes a video (color difference) signal input terminal into which a video (color difference) signal is inputted; reference numeral 103 denotes an image quality adjusting unit for controlling the luminance of an inputted video signal to adjust the image quality; reference numeral 113 denotes a video (luminance) signal output terminal from which a video (luminance) signal which has been subjected to image quality adjustment is output; reference numeral 114 denotes a video (color difference) signal output terminal from which a video (color difference) signal whish has been subjected to image quality adjustment is output; reference numerals 105A through 105H denote backlight driving circuits for the eight screen areas A through H shown in FIG. 2 respectively; reference numerals 106A through 106H denote backlights for the eight screen areas A through H shown in FIG. 2 respectively; and reference numerals 104A through 104H are image characteristics extraction units that correspond to the eight screen areas A through H shown in FIG. 2 respectively, the image characteristics extraction units being used as extraction units.

In the image characteristics extraction unit 104A; reference numeral 107A denotes a luminance distribution filter; reference numeral 108A denotes a luminance distribution extraction unit for extracting the pixel frequency distribution of an input video signal (video (luminance) signal) on a luminance level basis; reference numeral 111A denotes a color distribution filter; and reference numeral 112A denotes a specific color distribution extraction unit for extracting the pixel frequency distribution of specific color from a color-difference signal included in an input video signal (video (color difference) signal) of each of the screen areas A through H, the color-difference signal being determined from the luminance distribution of each of the backlights 106A through 106H. Reference numeral 109 denotes a control unit. The image characteristics extraction units 104B through 104H are also configured in the same manner as the image characteristics extraction unit 104A.

In the configuration shown in FIG. 1, a video (luminance) signal inputted from the video (luminance) signal input terminal 101 is supplied to the image quality adjusting unit 103 and the image characteristics extraction unit 104A through 104H. A video (luminance) signal, which has been inputted into the image characteristics extraction unit 104A, is supplied to the luminance distribution filter 107A.

FIGS. 3A through 3H are charts each illustrating characteristics of the luminance distribution filter for the screen areas A through H respectively. In each of FIGS. 3A through 3H, characteristics on the upper side show characteristics that depend on a vertical position. The horizontal axis indicates a vertical position of a liquid crystal panel shown in FIG. 2, whereas the vertical axis indicates a correction gain value of a video (luminance) signal. Characteristics on the lower side show characteristics that depend on a horizontal position. The horizontal axis indicates a horizontal position of the liquid crystal panel shown in FIG. 2, whereas the vertical axis indicates a correction gain value of the video (luminance) signal. An output signal of the luminance distribution filter 107A is calculated by the equation as follows: Output signal=(Input signal)×(Correction gain that depends on vertical position)×(Correction gain that depends on horizontal position). For example, when a luminance signal level of pixels existing in the screen area A shown in FIG. 2 is 255, a correction gain in the vertical direction is equivalent to 1.0, and a correction gain in the horizontal direction is equivalent to 1.0, in the luminance distribution filter 107A. Accordingly, the output signal of the luminance distribution filter 107A is calculated as follows: 255×(1.0)×(1.0)=255. However, as shown in FIGS. 3B through 3H, in the luminance distribution filters 107B through 107H, which exist in the video characteristics extraction unit 104B through 104H respectively, at least one of a correction gain in the vertical direction and a correction gain in the horizontal direction is equivalent to 0.0. Accordingly, an output signal of each of the luminance distribution filters 107B through 107H is calculated as follows: 255×0.0=0.

In the configuration shown in FIG. 1, the output signal of the luminance distribution filter 107A is supplied to the luminance distribution extraction unit 108A. The luminance distribution extraction unit 108A extracts, on a luminance level basis, the frequency distribution of pixel values that are included in one field or one frame of an input video signal. Each of the luminance distribution extraction units, which exist in the image characteristics extraction units 104B through 104H, also has the same function as that of the luminance distribution extraction unit 108A. For example, in the case of the input video signal shown in FIG. 2, the results on the luminance frequency distribution that each of the luminance distribution extraction units 108A through 108H has extracted are shown in FIGS. 4A through 4H respectively. In FIG. 4A, the horizontal axis indicates a luminance level, in which the luminance level becomes lower on the left side, and the luminance level becomes higher on the right side. The vertical axis indicates the frequency of pixels included in the luminance level. All pixels included in the screen area A correspond to a background whose color is white, and accordingly a luminance level of each of the pixels is the highest. Therefore, as shown in FIG. 4A, the luminance frequency distribution concentrates on the right most luminance level. In addition, pixels included in the screen area B correspond to the background whose color is white, or face video whose color is skin color. Therefore, as shown in FIG. 4B, the luminance frequency is distributed over the right most luminance level and a middle level that is brightish. Moreover, all pixels included in the screen area E correspond to a background whose color is black, and accordingly a luminance level of each of the pixels is the lowest. Therefore, as shown in FIG. 4E, the luminance frequency distribution concentrates on the left most luminance level. The results on the luminance frequency distribution that each of the luminance distribution extraction units 108A through 108H has extracted are supplied to a control circuit 9.

Next, in FIG. 1, a video (color difference) signal inputted from the video (color difference) signal input terminal 102 is supplied to the image quality adjusting unit 103 and the video characteristics extraction unit 104A through 104H. The video (color difference) signal, which has been inputted into the image characteristics extraction unit 104A, is supplied to the color distribution filter 111A.

FIGS. 5A through 5H are charts each illustrating characteristics of the color distribution filter for the screen areas A through H respectively. In each of FIGS. 5A through 5H, characteristics on the upper side show characteristics that depend on a vertical position. The horizontal axis indicates a vertical position of the liquid crystal panel shown in FIG. 2, whereas the vertical axis indicates a correction gain value for a video (color difference) signal. Characteristics on the lower side show characteristics that depend on a horizontal position. The horizontal axis indicates a horizontal position of the liquid crystal panel shown in FIG. 2, whereas the vertical axis indicates a correction gain value for the video (color difference) signal. An output signal of the color distribution filter 111A is calculated by the equation as follows: Output signal=(Input signal)×(Correction gain that depends on vertical position)×(Correction gain that depends on horizontal position). For example, when a color-difference signal level of the pixels existing in the screen area A shown in FIG. 2 is 255, a correction gain in the vertical direction is equivalent to 1.0, and a correction gain in the horizontal direction is equivalent to 1.0, in the color distribution filter 111A. Accordingly, the output signal of the color distribution filter 111A is calculated as follows: 255×(1.0)×(1.0)=255. However, as shown in FIGS. 5B through 5H, in the color distribution filters 111B through 111H, which exist in the image characteristics extraction unit 104B through 104H respectively, at least one of a correction gain in the vertical direction and a correction gain in the horizontal direction is equivalent to 0.0. Accordingly, an output signal of each of the color distribution filters 111B through 111H is calculated as follows: 255×0.0=0.

In FIG. 1, the output signal of the color distribution filter 111A is supplied to the specific color distribution extraction unit 112A. The specific color distribution extraction unit 112A extracts the pixel frequency distribution of specific color from a color-difference signal that is included in one field or one frame of an input video signal of the screen area A. Each of the specific color distribution extraction units, which are included in the video characteristics extraction units 104B through 104H, also has the same function as that of the specific color distribution extraction unit 112A. For example, in the case of a video input signal shown in FIG. 2, the results on specific color frequency distribution that each of the specific color distribution extraction units, which are included in the image characteristics extraction units 104B through 104H, has extracted are shown in FIG. 6B through 6H respectively. In FIG. 6A, the horizontal axis indicates a hue range, in which the hue becomes more bluish on the left side, and the hue becomes more cyanish on the right side. In addition, the vertical axis indicates the pixel frequency included in the hue range. All of the pixels included in the screen area A correspond to the background whose color is white, which is achromatic color. Therefore, as shown in FIG. 6A, no hue frequency is extracted as the specific color frequency distribution. Next, pixels included in the screen area B correspond to the background whose color is white, and the face video whose color is skin color. Therefore, as shown in FIG. 6B, the frequency within a hue range including skin color is extracted as the specific color frequency distribution. Further, all of the pixels included in the screen area E correspond to the background whose color is black, which is achromatic color. Therefore, as shown in FIG. 6E, no hue frequency is extracted as the specific color frequency distribution. The results on the specific color frequency distribution that each of the specific color distribution extraction units, which are included in the video characteristics extraction units 104B through 104H, has extracted are supplied to the control unit 109.

On the basis of the results on the luminance frequency distribution extracted by each of the luminance distribution extraction units 108A through 108H, and the results on the specific color frequency distribution extracted by the specific color distribution extraction units, which are included in the video characteristics extraction units 104B through 104H, the control unit 109 generates a backlight driving control signal to be supplied to the backlight driving circuit 105A through 105H.

FIG. 7 is a flowchart illustrating how a backlight driving control signal is generated by the control unit 109.

In FIG. 7, the process flows as follows:

(1) first of all, starting the operation to generate a backlight driving control signal from the screen area A shown in FIG. 2 (step S701);

(2) for the specific color frequency distribution of the screen area A, which has been extracted by the specific color distribution extraction unit 112A, making a judgment as to whether or not the frequency of predetermined specific hue exceeds a predetermined threshold value (step S702);

(3) as a result of the judgment made in the step S702, if the frequency of the specific hue in the screen area A does not exceed the threshold value, generating a backlight driving control signal for the screen area A on the basis of the luminance frequency distribution extracted by the luminance distribution extraction unit 108A (step S703);

(4) as a result of the judgment made in the step S702, if the frequency of the specific hue in the screen area A exceeds the threshold value, making a judgment as to whether or not the frequency of the predetermined specific hue in each of screen areas adjacent to the screen area A (more specifically, in each of the screen areas B, E, F) exceeds the threshold value in the specific color frequency distribution detected by the corresponding specific color distribution extraction unit (step S704);

(5) as a result of the judgment made in the step S704, if the frequency of the specific color hue does not exceed the threshold value in all of the adjacent screen areas, generating a backlight driving control signal for the screen area A in the step S703 on the basis of the luminance frequency distribution extracted by the luminance distribution extraction unit 108A;

(6) as a result of the judgment made in the step S704, if the frequency of the specific color hue exceeds the threshold value in any of the adjacent screen areas, setting an identical control flag of the screen area in which the frequency of the specific color hue exceeds the threshold value (step S705)—in the above conditions, a backlight driving control signal for the screen area A is not generated;

(7) also for the screen areas B through H, further performing the same processing as that performed for the screen area A, and then making a check as to whether or not the processing has been performed for all of the screen areas A through H (step S706); however, in the processing in the step S704, each of the screen areas B through H has different adjacent screen areas, which also differ from the adjacent screen areas of the screen area A;

(8) as a result of the check made in the step S706, if the processing to be performed for all of the screen areas A through H has been completed, generating a backlight driving control signal for the screen area whose identical control flag has been set (step S708)—in the case of the video signal shown in FIG. 2, an identical control flag of each of the screen areas B, C, F, G is set according to the result of extracting the specific color frequency distribution shown in FIG. 6, and accordingly, on the basis of the luminance frequency distribution extracted by the luminance distribution extraction units 108B, 108C, 108F, 108G, calculating the luminance frequency distribution on the assumption that the screen areas B, C, F, G belong to the same image area, and on the basis of the result of the calculation, generating a backlight driving control signal for the screen areas B, C, F, G;

(9) after that, ending the operation to generate the backlight driving control signal (step S709); and

(10) as a result of the check made in the step S706, if the processing to be performed for all of the screen areas A through H is not completed, shifting to the next screen area to be subjected to the processing (step S707), and then returning to the step S702 to make the judgment.

FIGS. 8A, 8B are charts each illustrating the backlight driving control signal at the time of generation thereof.

The control unit 109 includes predetermined weighted coefficient characteristics for the luminance frequency distribution as shown in FIG. 8A, and the backlight driving control signal characteristics for a total value of the frequency distribution, which has been corrected by weighted coefficient characteristics for the luminance frequency distribution, as shown in FIG. 8B. The control unit 109 generates a backlight driving control signal from the luminance distribution characteristics inputted on the basis of these characteristics. These characteristics enable to generate such a backlight driving control signal that with the increase in pixel frequency whose luminance level is low in the luminance frequency distribution, the backlight luminance becomes lower, and generates such a backlight driving control signal that with the increase in pixel frequency whose luminance level is high in the luminance frequency distribution, the backlight luminance becomes higher. On the basis of the backlight driving control signals of the screen areas A through H, the backlight driving circuits 105A through 105H adjust the light quantity of the backlights 106A through 106H respectively. As a result of the above-described control, the backlight luminance becomes high in the screen areas A, D, whereas the backlight luminance becomes low in the screen areas E, H. This makes it possible to display high-contrast images. In addition, because the backlight luminance is equally controlled in the screen areas B, C, F, G, it is possible to suppress the change in luminance of an object that is displayed as the same object (in the description of this embodiment, a person's face displayed in the screens).

Moreover, on the basis of the results extracted by the luminance frequency distribution and the results by extracted the specific color frequency, which have been supplied by the video characteristics extraction units 104A through 104H, and on the basis of the resulted backlight driving control signal, the control unit 109 generates a contrast correction control signal of a luminance signal, a hue correction control signal of a color-difference signal, and a color-saturation correction control signal, and then supplies the generated control signals to the image quality adjusting unit 103 as image-quality adjustment control signals. On the basis of the image-quality adjustment control signal described above, the image quality adjusting unit 103 adjusts the input video (luminance) signal and the input video (color difference) signal, and then outputs the adjusted input video (luminance) signal and the adjusted input video (color difference) signal to the video (luminance) signal output terminal 113 and the video (color difference) signal output terminal 114 respectively. The video (luminance) signal and the video (color difference) signal, which have been output to the video (luminance) signal output terminal 113 and the video (color difference) signal output terminal 114 respectively, are displayed on a liquid crystal panel (not illustrated) as images through a liquid crystal panel controller (not illustrated).

According to the above-described embodiment of the present invention, by adjusting the light quantity of a plurality of backlights on the basis of characteristics of an input video signal for each screen area, it is possible to suppress the occurrence of untrue black of dark part, and thereby to improve the contrast. In addition, by detecting the specific color distribution on a screen area basis, it is possible to suppress the change in luminance of the same object image (for example, a person's face) that is displayed across the plurality of screen areas.

Incidentally, although the number of screen areas is eight in the above-described embodiment, the present invention is not limited to this. Irrespective of the number of screen areas, the number of image characteristics extraction units, the number of backlight driving circuits, and the number of backlights have only to be equalized to the number of screen areas. In addition, although the screen is divided into the screen areas in both the longitudinal and lateral directions, the screen may also be divided into the screen areas only in the longitudinal direction, or only in the lateral direction. Moreover, the image characteristics extraction unit, the control unit, and the image quality adjusting unit, which are elements according to the present invention, may also be configured by hardware, or may also be implemented by software processing executed by a microcomputer. Further, although the specific color is detected as one color in the description of this embodiment, the control may also be performed with two or more colors being specified. In addition, it may also be so configured that, for another video display part at the time of displaying PinP (Picture in Picture) or at the time of displaying a plurality of screens, a backlight driving control signal is generated in a state in which even a screen area which is adjacent on a panel is not included in an adjacent screen area.

Moreover, for the purpose of improving the moving-image display performance of liquid crystal display apparatuses, for example, the following techniques are known: backlight blink that provides a low-luminance light emission period during which the backlight quantity is decreased to a minimum level in all screen areas at the same timing during one frame period of a video signal; and backlight scroll blink in which a screen is divided into a plurality of small screen areas in the longitudinal direction, and each low-luminance light emission period is successively set. When the backlight blink is use, the plurality of backlight driving circuits 105A through 105H drive the backlights 106A through 106H respectively with one frame period of an input video signal time-divided into a backlight quantity variable period and a backlight quantity minimum value period. In this case, the backlights 106A through 106H are driven with the backlight luminance control amount adjusted during the backlight quantity variable period so that the backlight quantity, which has been time-integrated during the one frame period, becomes the backlight luminance specified by luminance control amount information of the backlights 106A through 106H, the luminance control amount information being supplied from the control unit 109. On the other hand, in the case of the backlight scroll blink, the plurality of backlight driving circuits perform not only the same processing as that of the backlight blink described above, but also controls backlight groups by using the backlight quantity variable period and the backlight quantity minimum value period, which are the same with respect to the time, the backlight groups being included in a plurality of small screen areas into which a screen area is divided in the longitudinal direction, and thereby drives backlights in such a manner that the start time of a backlight quantity variable period differs among the backlight groups. According to the present invention, it is also possible to operate the backlight blink and the backlight scroll blink in combination. In this case, the backlight quantity during a backlight light emission period other than the low-luminance light emission period is adjusted so that the backlight quantity, which has been time-integrated during one frame period, becomes the light emission amount inreponse to a backlight driving control signal received from the control unit 109. In any of the techniques described above, that is to say, the backlight blink, the backlight scroll blink, or the combination of the backlight blink with the backlight scroll blink, it is possible to produce the same effects as those of the embodiment described with reference to FIGS. 1 through 8.

As described above, according to the present invention, it is possible to provide a liquid crystal display apparatus that is capable of suppressing untrue black with the change in luminance of an image, which is displayed as the same object, reduced in response to characteristics of images to be displayed so that the contrast can be improved.

The present invention can also be implemented in other modes without deviating from the spirit or principal features thereof. Therefore, all of the above-descried embodiments are merely simple examples of the present invention at all points, and accordingly the present invention should not be restrictively understood. The scope of the present invention is defined by claims. Moreover, all modification and changes, which belong to equivalent claims of the claims, fall with the scope of the present invention.

What is claimed is:

1. A liquid crystal display apparatus that irradiates a liquid crystal panel with light beams from a plurality of backlights so as to form and display an image corresponding to a video signal, said liquid crystal display apparatus comprising:
an extraction unit for extracting the pixel frequency distribution of an input video signal on a luminance level basis, and for extracting the pixel frequency distribution of specific color from a color-difference signal of the input video signal in a screen area, the color-difference signal being determined from the luminance distribution of the plurality of backlights;
a control unit for determining the control amount of the luminance of the plurality of backlights, and the correction amount of the luminance of the liquid crystal panel, on the basis of the result of the extraction, and for outputting a control signal corresponding to the control amount of the luminance and a control signal corresponding to the correction amount of the luminance;
a plurality of backlight driving circuits, each of which drives each of the plurality of backlights on the basis of the control amount of the luminance; and
an image quality adjusting unit for controlling the luminance of the input video signal on the basis of the correction amount of the luminance;
wherein, on a screen area basis, the luminance of the input video signal and the luminance of the backlights are controlled in response to the pixel frequency distribution of specific color extracted from the input video signal.

2. The liquid crystal display apparatus according to claim 1, wherein:
said extraction unit includes:
a plurality of luminance distribution filters that are provided in association with the luminance distribution of the plurality of backlights;
a plurality of luminance distribution extraction units for extracting the pixel frequency distribution of the input video signal on a luminance level basis, the input video signal being inputted through the plurality of luminance distribution filters; and
a specific color distribution extraction unit for extracting the pixel frequency distribution of specific color from a color-difference signal of the input video signal included in a screen area, the color-difference signal being determined from the luminance distribution of the plurality of backlights;
wherein said control unit calculates the correction amount of the luminance of the liquid crystal panel and the control amount of the luminance of the plurality of backlights on the basis of pixel frequency distribution information signals output by the plurality of luminance distribution extraction units and specific color pixel frequency distribution information signal output by the specific color distribution extraction unit, and thereby generates a control signal in response to the result of the calculation.

3. The liquid crystal display apparatus according to claim 1, wherein:
said control unit controls the backlight driving circuits so that as a result of judgments made on the basis of the pixel frequency distribution of specific color, which has been extracted on a screen area basis, if it is judged that there is a screen area, whose pixel frequency of specific color exceeds a predetermined value, among screen areas that are adjacent to one another, the luminance of backlights, each of which corresponds to each of the screen areas that are adjacent to one another, is kept uniform.

4. The liquid crystal display apparatus according to claim 2, wherein:
said control unit controls the backlight driving circuits so that as a result of judgments made on the basis of the pixel frequency distribution of specific color, which has been extracted on a screen area basis, if it is judged that there is a screen area, whose pixel frequency of specific color exceeds a predetermined value, among screen areas that are adjacent to one another, the luminance of backlights, each of which corresponds to each of the screen areas that are adjacent to one another, is kept uniform.

5. The liquid crystal display apparatus according to claim 1, wherein:
said plurality of backlights are located in such a manner that a screen is divided into a plurality of screen areas in the longitudinal direction by the luminance distribution, or in such a manner that the screen is divided into a plurality of screen areas in the longitudinal and lateral directions by the luminance distribution.

6. The liquid crystal display apparatus according to claim 2, wherein:
said plurality of backlights are located in such a manner that a screen is divided into a plurality of screen areas in the longitudinal direction by the luminance distribution, or in such a manner that the screen is divided into a plurality of screen areas in the longitudinal and lateral directions by the luminance distribution.

7. The liquid crystal display apparatus according to claim 1, wherein:
the number of the extraction units provided for each of the plurality of backlights is two or more.

8. The liquid crystal display apparatus according to claim 2, wherein:
the number of the extraction units provided for each of the plurality of backlights is two or more.

9. The liquid crystal display apparatus according to claim 1, wherein:
each of the plurality of backlight driving circuits drives the backlight with one frame period of an input video signal divided into a backlight quantity variable period and a backlight quantity minimum value period, and drives the backlight with the backlight luminance control amount adjusted during the backlight quantity variable period so that the backlight quantity, which has been time-integrated by the one frame period, becomes the backlight luminance specified by the backlight luminance control amount information supplied by the control unit.

10. The liquid crystal display apparatus according to claim 2, wherein:
each of the plurality of backlight driving circuits drives the backlight with one frame period of an input video signal divided into a backlight quantity variable period and a backlight quantity minimum value period, and drives the backlight with the backlight luminance control amount adjusted during the backlight quantity variable period so that the backlight quantity, which has been time-integrated by the one frame period, becomes the backlight luminance specified by the backlight luminance control amount information supplied by the control unit.

11. The liquid crystal display apparatus according to claim 9, wherein:
the plurality of backlight driving circuits control backlight groups, which are included in a plurality of small screen areas into which a screen area is divided in the longitudinal direction, according to the backlight quantity variable period and the backlight quantity minimum value period, which are the same with respect to the time, whereby the start time of a backlight quantity variable period differs among the backlight groups.

12. The liquid crystal display apparatus according to claim 10, wherein:
the plurality of backlight driving circuits control backlight groups, which are included in a plurality of small screen areas into which a screen area is divided in the longitudinal direction, according to the backlight quantity variable period and the backlight quantity minimum value period, which are the same with respect to the time, whereby the start time of a backlight quantity variable period differs among the backlight groups.

13. A luminance control method of a liquid crystal display apparatus that irradiates a liquid crystal panel with light beams from a plurality of backlights so as to form and display an image corresponding to a video signal, said luminance control method comprising the steps of:
extracting the pixel frequency distribution of an input video signal on a luminance level basis, and extracting the pixel frequency distribution of specific color from a color-difference signal of the input video signal included in a screen area, the color-difference signal being determined from the luminance distribution of the plurality of backlights;
calculating the correction amount of the luminance of the liquid crystal panel, and the control amount of the luminance of the plurality of backlights, on the basis of the result of the extraction; and
driving the plurality of backlights on the basis of the calculated control amount of the luminance, and controlling the luminance of the input video signal on the basis of the correction amount of the luminance;
wherein, on a screen area basis, the luminance of the input video signal and the luminance of the backlights are controlled according to the pixel frequency distribution of specific color extracted from the input video signal.
